(19) United States
(12) Patent Application Publication
(10) Pub. No.: US 2020/0221190 A1
(43) Pub. Date: Jul. 9, 2020

(54) TECHNIQUES FOR ASSOCIATING INTERACTION DATA WITH VIDEO CONTENT

(71) Applicant: Microsoft Technology Licensing, LLC, Redmond, WA (US)

(72) Inventor: Kankan BHATTACHARJEE, Hyderabad (IN)

(21) Appl. No.: 16/241,605

(22) Filed: Jan. 7, 2019

(51) Int. Cl. H04N 21/8545; H04N 21/845; H04N 21/858

(52) U.S. Cl. CPC H04N 21/8545; H04N 21/858; H04N 21/8456

(57) ABSTRACT

Examples described herein generally relate to obtaining, from a remote source, media content for rendering in a media player, obtaining, based on obtaining the media content, metadata related to the media content including an indication of a question related to the media content and a timestamp associated with the media content to which the question applies, rendering the media content within the media player, and displaying, by the media player and while rendering the media content, an indicator of the timestamp related to displaying the question.

### BACKGROUND

Use of computing devices is becoming more ubiquitous by the day. Computing devices range from standard desktop computers to wearable computing technology and beyond. Computing devices are often used to consume media content, which may be instructional in nature, used for entertainment, etc. Repositories exist for storing and retrieving instructional content, such as technical documents, video content, audio content, etc., typically authored by a person with expect knowledge explaining how to perform a technical task. In addition, question-and-answer (Q&A) type of repositories exist for discussing the content offline, as a separate forum from the content itself, to gain a better understanding of the content, to otherwise single out certain details of the content, and/or the like.

### SUMMARY

The following presents a simplified summary of one or more examples in order to provide a basic understanding of such examples. This summary is not an extensive overview of all contemplated examples, and is intended to neither identify key or critical elements of all examples nor delineate the scope of any or all examples. Its sole purpose is to present some concepts of one or more examples in a simplified form as a prelude to the more detailed description that is presented later.

In an example, a computer-implemented method for obtaining and rendering media content by a computing device is provided. The method includes obtaining, from a remote source, media content for rendering in a media player, obtaining, based on obtaining the media content, metadata related to the media content including an indication of a question related to the media content and a timestamp associated with the media content to which the question applies, rendering the media content within the media player, and displaying, by the media player and while rendering the media content, an indicator of the timestamp related to displaying the question.

In another example, a computing device for associating metadata with media content is provided. The computing device includes a memory storing one or more parameters or instructions for associating the metadata with the media content, and at least one processor coupled to the memory. The at least one processor is configured to obtain, from a remote source, the media content for rendering in a media player, obtain, based on obtaining the media content, the metadata related to the media content including an indication of a question related to the media content and a timestamp associated with the media content to which the question applies, render the media content within the media player, and display, by the media player and while rendering the media content, an indicator of the timestamp related to displaying the question.

In another example, a computer-implemented method for obtaining and rendering media content by a computing device is provided. The method includes receiving, from a first media player, metadata, including a timestamp and a question, to be associated with media content, receiving, from a second media player, a request for the media content, and providing the media content and the metadata to the second media player for displaying the question in relation to the timestamp while rendering the media content.

To the accomplishment of the foregoing and related ends, the one or more examples comprise the features hereinafter fully described and particularly pointed out in the claims. The following description and the annexed drawings set forth in detail certain illustrative features of the one or more examples. These features are indicative, however, of but a few of the various ways in which the principles of various examples may be employed, and this description is intended to include all such examples and their equivalents.

### BRIEF DESCRIPTION OF THE DRAWINGS

FIG. 1 is a schematic diagram of an example of a computing device for associating metadata with media content in accordance with examples described herein.

FIG. 2 is a flow diagram of an example of displaying metadata with media content in accordance with examples described herein.

FIG. 3 is a flow diagram of an example of associating a question with media content in accordance with examples described herein.

FIG. 4 is a flow diagram of an example of storing metadata for media content in accordance with examples described herein.

FIG. 5 is a flow diagram of an example of notifying of a question associated with media content in accordance with examples described herein.

FIG. 6 is an example of an interface for rendering media content and displaying metadata in accordance with examples described herein.

FIG. 7 is a schematic diagram of an example of a computing device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Described herein are various examples related to associating media content with interaction data such that the interaction data can be displayed along with, or otherwise associated with, the media content. For example, metadata related to the media content can be stored and retrieved for providing with rendering of the media content, where the metadata can include questions related to the media content, answers to the questions, social discussions around the media content, etc. The metadata can be associated with a timestamp in the media content such that the metadata is displayed or otherwise indicated based on a time associated with rendering the media content and the timestamp. For example, where the media content includes video content, the video player can display questions and/or answers during playback of the video. This may include displaying the questions and/or answers in a frame of the video player, displaying indicators of the questions and/or answers as a link to the questions and/or answers (e.g., as a pop-up, as a line in a progress bar for the video playback, etc.). Thus, a user watching the video can be notified of questions and/or answers that are temporally associated with playback of the video at an appropriate time.

In addition, some examples relate to allowing, via the media player, posing of a question related to the content where a timestamp can be recorded and associated with the question. The question and timestamp can be stored as metadata for the media content to facilitate providing the metadata for displaying the question in subsequent rendering of the media content. In another example, a mechanism for answering the question can be provided via the media player itself and/or using another interface. In either case, the answer can additionally be saved as metadata for the media content and/or associated with the question to facilitate displaying the answer along with the question during rendering of the media content. Additionally, for example, the answers can be voted to facilitate ranking the answers in terms of number of votes. Aspects described herein can allow for associating the interaction data with the media content to facilitate providing context to questions and/or answers regarding the media content and to facilitate displaying relevant questions and/or answers during rendering of the content to provide additional information to users consuming the content.

Though described in terms of questions and answers throughout, the concepts described herein can be applied to social discussions which may or may not explicitly include a question or an answer. In such implementations, the “question” described herein may include an initial post of a social discussion, and the “answers” described herein can include additional posts of the social discussion.

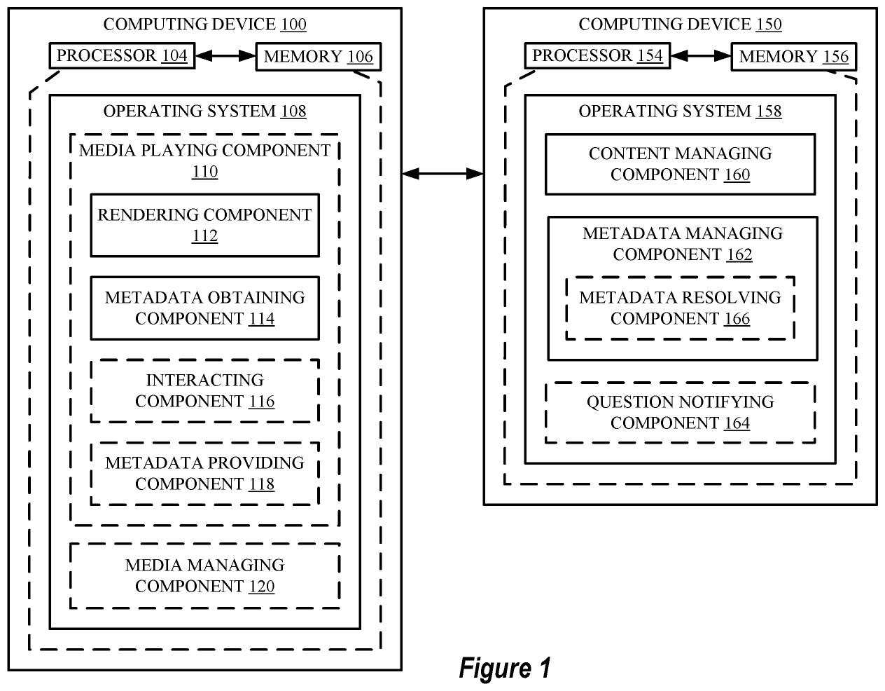

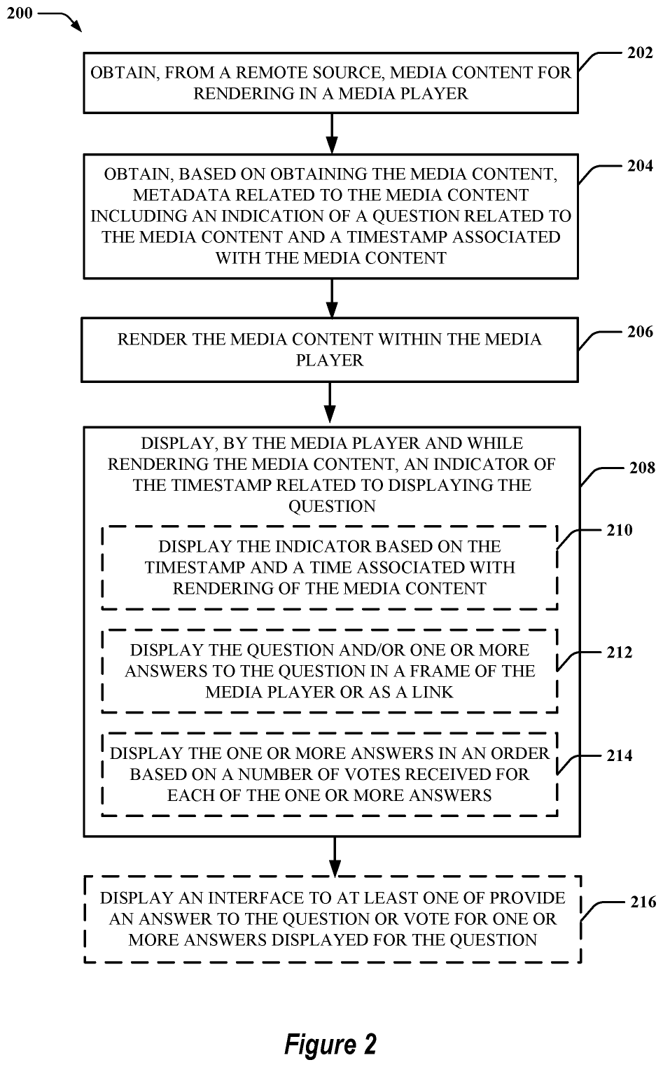

Turning now to FIGS. 1-7, examples are depicted with reference to one or more components and one or more methods that may perform the actions or operations described herein, where components and/or actions/operations in dashed line may be optional. Although the operations described below in FIG. 2-4 are presented in a particular order and/or as being performed by an example component, the ordering of the actions and the components performing the actions may be varied, in some examples, depending on the implementation. Moreover, in some examples, one or more of the following actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a computing device 100, a computing device 150, and/or related components for associating interaction data with video content in accordance with aspects described herein. For example, computing device 100 can include or can otherwise be coupled with a processor 104 and/or memory 106, where the processor 104 and/or memory 106 can be configured to execute or store instructions or other parameters related to associating interaction data with media content, as described herein. Computing device 100 can execute an operating system 108 (e.g., via processor 104 and/or memory 106) for providing an environment for executing one or more applications, such as an optional media playing component 110 for rendering media content that may be obtained from a remote source, an optional media managing component 120 for providing media content for storage at the remote source, etc.

Media playing component 110 can include a rendering component 112 for rendering media content on the computing device 100 (e.g., displaying a video, playing an audio file, displaying a document, displaying a slideshow presentation, etc.), and a metadata obtaining component 114 for obtaining metadata related to the media content, where the metadata can include interaction data for the media content. Media playing component 110 can also optionally include an interacting component 116 for facilitating interacting with the media content, such as generating metadata to be associated with the media content, and/or a metadata providing component 118 for providing the metadata for storing with the media content.

In addition, FIG. 1 illustrates an example of a computing device 150 that can include or can otherwise be coupled with a processor 154 and/or memory 156, where the processor 154 and/or memory 156 can be configured to execute or store instructions or other parameters related to associating interaction data with media content, as described herein. Computing device 150 can execute an operating system 158 (e.g., via processor 154 and/or memory 156) for providing an environment for executing one or more applications, such as an optional content managing component 160 for managing media content and/or storage thereof for providing to devices for rendering, a metadata managing component 162 for storing and/or managing metadata associated with the media content for presenting in conjunction with rendering the media content, and/or a question notifying component 164 for notifying an author of media content of a question stored as metadata for the media content. In an example, metadata managing component 162 may optionally include a metadata resolving component 166 for resolving similar metadata presented for media content (e.g., having similar subject, related to a similar timestamp within the media content, etc.).

For example, computing device 100 and computing device 150 may communicate with one another over one or more networks. Computing device 100 can generate media content for storing on computing device 150 and/or can receive media content from computing device 150 for rendering (e.g., on a display of computing device 100, through an audio output of computing device 100, etc.). Computing device 100 can also receive metadata for the media content from computing device 150 for associating with the media content during rendering and/or can provide additional metadata to the computing device 150 for storing with the media content (e.g., for providing in subsequent rendering of the media content by another computing device).

FIG. 2 is a flowchart of an example of a method 200 for associating metadata including interaction data with media content during rendering of the media content. For example, method 200 can be performed by the computing device 100, and is accordingly described with reference to FIG. 1, as a non-limiting example of an environment for carrying out method 200.

In method 200, at action 202, media content can be obtained from a remote source for rendering in a media player. In an example, media playing component 110, e.g., in conjunction with processor 104, memory 106, etc., can obtain, from the remote source (e.g., computing device 150), media content for rendering in a media player. For example, media playing component 110 can request the content from the remote source (e.g., computing device 150) based on a request initiated in the media playing component 110. For example, a user may interact with the media playing component 110, via computing device 100, to request the media content. For example, the request can occur by activating a link to the media content (e.g., a hypertext transport protocol (HTTP) or other link that indicates a network address to the remote source and the media content thereon). Media playing component 110 can according request the media content from the remote source, and can receive the remote content for rendering on the computing device 100.

As described, the media content can relate to a video that media playing component 110 can playback on the computing device 100 by displaying the video on a user interface displayed on a display device of the computing device 100 (e.g., a monitor, liquid crystal display (LCD) panel, etc.). In another example, the media content can relate to an audio file to play on another output device of the computing device 100, such as via a sound card through one or more speakers. In this example, media playing component 110 may include a visual interface to control playback of the audio file. In yet another example, the media content may be a document, and the media playing component 110 can include a word processing application, a document viewing application, a slideshow presentation application, etc. In any case, media playing component 110 can be configured to render the media content for consumption by a user operating the computing device 100.

In method 200, at action 204, metadata related to the media content can be obtained, based on obtaining the media content, including an indication of a question related to the media content and a timestamp associated with the media content. In an example, metadata obtaining component 114, e.g., in conjunction with processor 104, memory 106, media playing component 110, etc., can obtain, based on obtaining the media content, metadata related to the media content including an indication of a question related to the media content and a timestamp associated with the media content. For example, the timestamp can be a timestamp in a duration of the media content at which the question is posed or otherwise deemed relevant to the media content. The metadata may be obtained from the remote source from which the media content is obtained, or may be obtained from a different remote source, from the memory 106 of computing device 100, and/or the like. The metadata may be associated to the media content by one or more identifiers in the metadata that correspond to the media content. As described, the metadata can include one or more questions related to the media content, one or more answers to the one or more questions, and/or the like, and associated timestamps. In another example, the metadata can relate to links to the questions and/or answers, along with associated timestamps.

In method 200, at action 206, the media content can be rendered within the media player. In an example, media playing component 110, e.g., in conjunction with processor 104, memory 106, etc., can render the content within the media player. As described, media playing component 110 can include a video player for rendering video content, an audio player for rendering audio content, a document display or editing application for rendering a document, a slideshow presentation application for rendering a slideshow, etc. In one example, media playing component 110 can include multiple frames for rendering the media content, displaying related metadata, displaying other media links, advertisements, etc. In addition, the media playing component 110 may include an application executing on operating system 108, a plug-in executing via another application, such as a web browser, and/or the like.

In method 200, at action 208, an indication of the timestamp related to displaying the question can be displayed, by the media player and while rendering the media content. In an example, media playing component 110, e.g., in conjunction with processor 104, memory 106, etc., can display, by the media player and while rendering the media content, the indication of the timestamp related to displaying the question. For example, the indication of the timestamp may be the question itself, and the question (or a link to a pop-up, webpage, or other construct that displays the question) may be displayed in a frame of the media player when the associated timestamp is equal to or within a threshold range of a rendering time associated with rendering the media content. In another example, the indication of the timestamp may include a bar or icon overlaid on a progress bar on the interface of the media player associated with rendering the media content, where interacting with the indication may cause display of the question and/or a link to a pop-up, webpage, or other construct that displays the question.

In method 200, optionally at action 210, displaying the indication of the timestamp can also include displaying the indicator based on the timestamp and a time associated with rendering of the media content. In an example, media playing component 110, e.g., in conjunction with processor 104, memory 106, etc., can display the indicator based on the timestamp and a time associated with rendering of the media content. As described, for example, media playing component 110 can display the indicator as a mark, icon, etc. on a time duration associated with rendering of the media content, where the indicator is indicative of the timestamp. In this regard, a user consuming the media content can interact with the indicator to display the question and/or associated answers or other information. In another example, media playing component 110 can display the indication at a time during rendering that is within a threshold before and/or after the timestamp associated with the question.

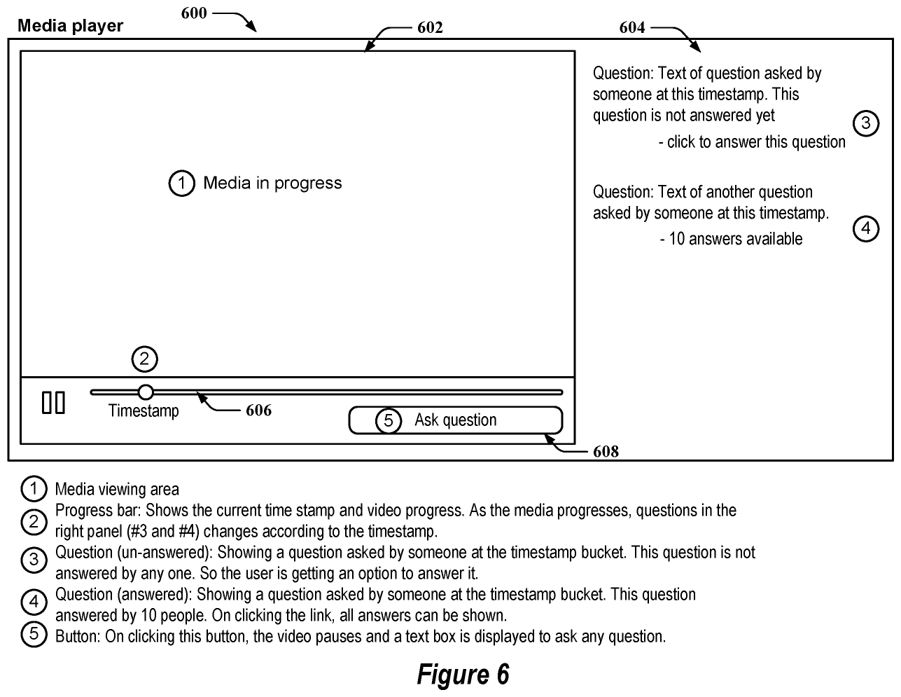

In method 200, optionally at action 212, displaying the indication of the timestamp can also include displaying the question and/or one or more answers to the question in a frame of the media player or as a link. In an example, media playing component 110, e.g., in conjunction with processor 104, memory 106, etc., can display the question and/or one or more answers to the question in a frame of the media player or as a link. For example, media playing component 110 can display a list of answers to the question as a collapsed link to the answers, where clicking on the collapsed link can cause multiple answers to be displayed for the question. In another example, media playing component 110 can display the answers as a pop-up, a webpage, or other construct. An example is shown in FIG. 6.

FIG. 6 illustrates an example of a media player interface 600 with a media rendering frame 602 and an interaction data frame 604 (also referred to herein as a “timestamp bucket” for displaying interaction data temporally relevant to the media content. Media rendering frame 602 can include a rendering progress indicator 606 that can indicate a current point in time of the rendering and/or a button 608 to facilitate asking a question relevant to the media content for including as interaction metadata, as described herein. In this example, media playing component 110 can render the media content in media rendering frame 602, which can include a video, audio file, document, slideshow presentation, etc. For example, the rendering progress indicator 606 can indicate a current time of the rendering within a duration of the media content. For a document or slideshow presentation, for example, the rendering progress indicator 606 can indicate a progress (e.g., number of pages, percentage of pages consumed or remaining, etc.) in the document or slideshow presentation between a first page and last page (or first slide and last slide).

In this example, media playing component 110 can populate the interaction data frame 604 with interaction metadata obtained for the media content, as described above. For example, media playing component 110 can list, in the interaction data frame 604, questions that are in the metadata, along with a link to related answers, and may do so based on a timestamp (or progress-stamp, which may be a page number or percentage of pages consumed or remaining for a document or slideshow) associated with the questions and answers (e.g., in the metadata) and a time or progress of the media content rendered in media rendering frame 602 (e.g., based on or otherwise indicated by the rendering progress indicator 606). In this regard, as the media progresses, media playing component 110 can change the questions and/or answers that appear in the interaction data frame 604 based on the time or progress indicated by the rendering progress indicator 606.

As described further herein, the button 608 can be activated (e.g., by a user consuming the media content) to post a question to the interaction metadata. When the button 608 is activated, media playing component 110 can pause the media content, display another interface for inputting the question, and once the question is entered (e.g., when an acknowledging indicator or button is activated), media playing component 110 can record the question and a timestamp for the question based on a time or progress of the media content indicated by the rendering progress indicator 606. Media playing component 110 can send the question and timestamp to another source or device for storing as interaction metadata for the media content, as described further herein, to cause display of the question based on the timestamp when rendering the media content, as described above.

Referring back to FIG. 2, in method 200, optionally at action 214, displaying the indication of the timestamp can also include displaying the one or more answers in an order based on a number of votes received for each of the one or more answers. In an example, media playing component 110, e.g., in conjunction with processor 104, memory 106, etc., can display the one or more answers in an order based on the number of votes received for each of the one or more answers. For example, the interaction metadata may include a number of votes for each of one or more answers to a question, which may be received via a media playing component 110 when rendering media content and displaying associated interaction metadata. As described further herein, the votes can be stored as metadata and used to rank the one or more answers for displaying in an order (e.g., in an interaction data frame 604), such as displaying an answer with the most votes first, the second most votes second, and so on. Other criteria can be used to order the one or more answers as well, such as a current time of day, day of year, etc. the answer is provided (e.g., oldest first), a random order, an ordering based on number of characters in the answer, etc.

In addition, in method 200, optionally at action 216, an interface to at least one of provide an answer to the questions or vote for one or more answers displayed for the question can be displayed. In an example, media playing component 110, e.g., in conjunction with processor 104, memory 106, etc., can display the interface to at least one of provide an answer to the question or vote for one or more answers displayed for the question. For example, media playing component 110 can display the interface as part of displaying the question and/or one or more existing answers for the question. Referring to FIG. 6, for example, media playing component 110 can display the interface as the interaction data frame 604 including the question and a link to provide an answer to the question and/or a link to answers provided for the question, where the link to answers may include a link to provide an answer.

As described herein, where an answer is provided, media playing component 110 can record the answer and associate the answer with the question in the interaction metadata, which may include notifying a remote source of the answer to the question for storing and subsequently providing to another media player for rendering the media content and displaying the associated interaction metadata. Similarly, for example, media playing component 110 may associate the answer with the question based on the timestamp and a time associated with rendering of the media content. For example, media playing component 110 may allow for specifying the answer via prompt for entering text, a media session for inserting other media with the answer, such as a video, audio, etc., and/or the like.

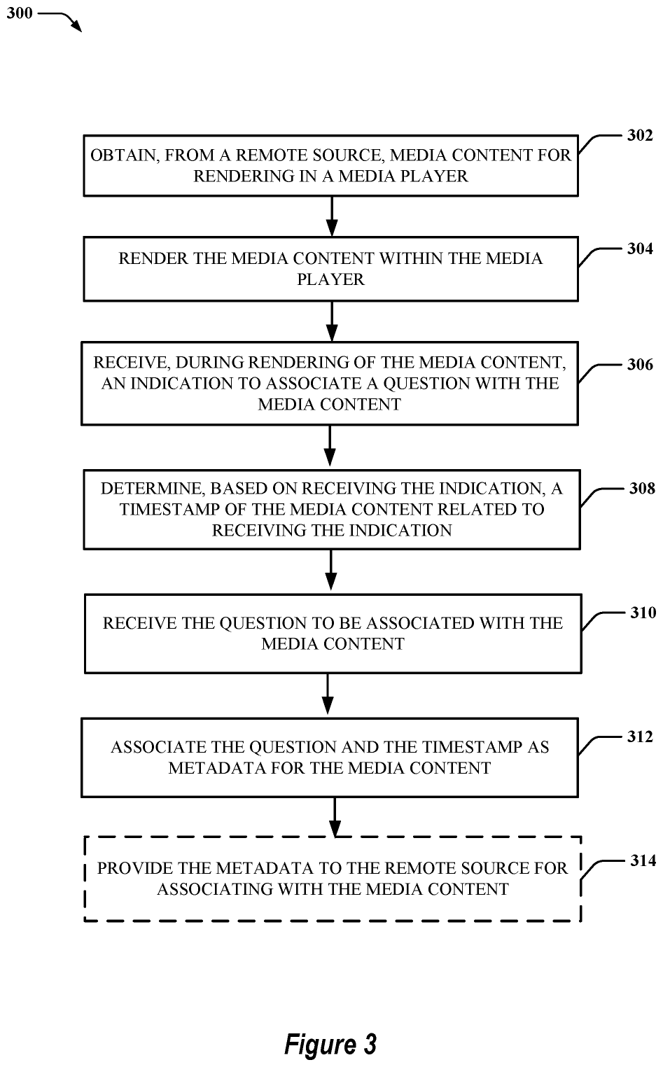

FIG. 3 is a flowchart of an example of a method 300 for generating metadata including interaction data to be associated with media content during rendering of the media content. For example, method 300 can be performed by the computing device 100, and is accordingly described with reference to FIG. 1, as a non-limiting example of an environment for carrying out method 300.

In method 300, at action 302, media content for rendering in a media player can be obtained from a remote source. In an example, media playing component 110, e.g., in conjunction with processor 104, memory 106, etc., can obtain, from the remote source (e.g., computing device 150), media content for rendering in a media player, as described with respect to action 202 in method 200 above.

In method 300, at action 304, the media content can be rendered within the media player. In an example, media playing component 110, e.g., in conjunction with processor 104, memory 106, etc., can render the media content within the media player, as described with respect to action 206 in method 200 above and referring to the interface of FIG. 6.

In method 300, at action 306, an indication to associate a question with the media content can be received during rendering of the media content. In an example, interacting component 116, e.g., in conjunction with processor 104, memory 106, media playing component 110 etc., can receive, during rendering of the media content, an indication to associate a question with the media content. For example, interacting component 116 can receive the indication based on interaction (e.g., by a user) with an interface configured to allow for inputting a question. As described, for example, this may include a button in the media player (e.g., button 608 in FIG. 6) that can allow for inputting a question relative to a time or progress of the media content.

In method 300, at action 308, a timestamp of the media content related to receiving the indication can be determined based on receiving the indication. In an example, interacting component 116, e.g., in conjunction with processor 104, memory 106, media playing component 110 etc., can determine, based on receiving the indication, the timestamp of the media content related to receiving the indication. For example, interacting component 116 can determine a time or progress of the media content at the instant the question is received or otherwise at an instant when a desire to ask a question is determined. For example, as described, media playing component 110 can include a button (such as button 608 in FIG. 6) for inputting a question related to the media content, and the media content can be paused or otherwise a time or progress of the media content can be determined when the button is activated. The time or progress can be recorded with the question for subsequent association thereof.

In method 300, at action 310, the question to be associated with the media content can be received. In an example, interacting component 116, e.g., in conjunction with processor 104, memory 106, media playing component 110 etc., can receive the question to be associated with the media content. For example, interacting component 116 can receive the question from another interface provided for inputting the question (e.g., after activating the button 608 or otherwise).

In method 300, at action 312, the question and the timestamp can be associated as metadata for the media content. In an example, interacting component 116, e.g., in conjunction with processor 104, memory 106, media playing component 110 etc., can associate the question and the timestamp as metadata for the media content. In this regard, media playing component 110, and/or similar components of other devices, can display the question during rendering of the media content based on the timestamp and a time or progress of the media content, as described above. For example, interacting component 116 can associate the question and the timestamp in a data structure, data file (e.g., extensible markup language (XML) file) or other hierarchical, relational, etc. data construct for subsequent retrieval and display when rendering the associated media content.

In method 300, optionally at action 314, the metadata can be provided to the remote source for associating with the media content. In an example, metadata providing component 118, e.g., in conjunction with processor 104, memory 106, media playing component 110 etc., can provide the metadata to the remote source for associating with the media content. For example, metadata providing component 118 can provide the metadata to the same remote source from which the media content is received for storing and providing with the media content, as described. In another example, metadata providing component 118 can additionally or alternatively provide the metadata to another remote source that can store the metadata separately from the media content, and/or the like.

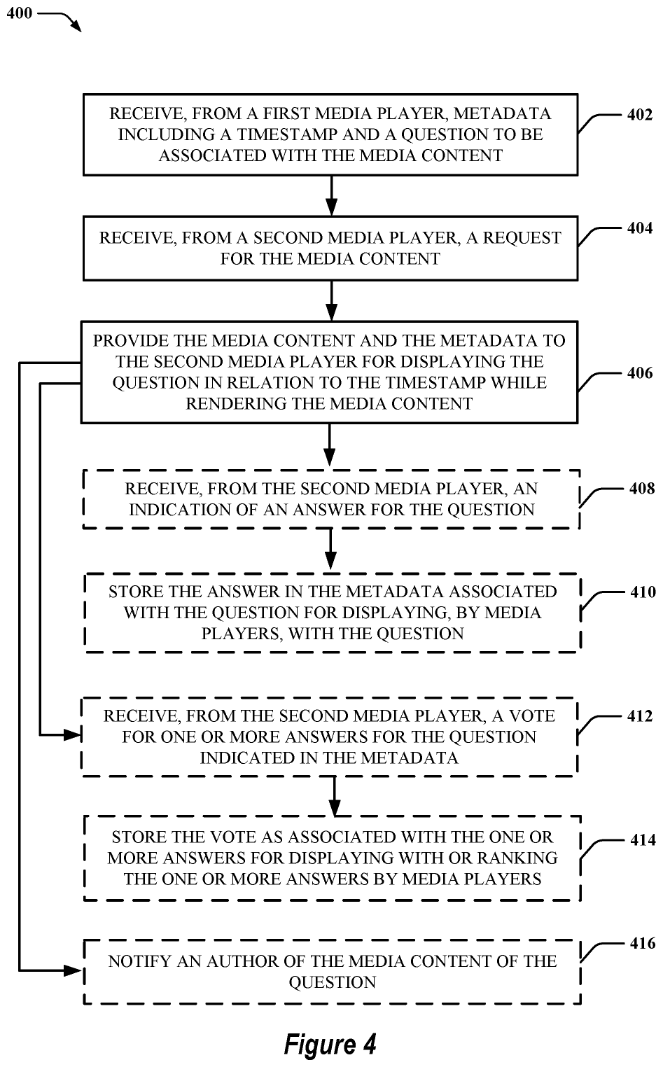

FIG. 4 is a flowchart of an example of a method 400 for receiving metadata including interaction data and associating the data with media content. For example, method 400 can be performed by the computing device 150, and is accordingly described with reference to FIG. 1, as a non-limiting example of an environment for carrying out method 400.

In method 400, at action 402, metadata including a timestamp and a question to be associated with the media content can be received from a first media player. In an example, metadata managing component 162, e.g., in conjunction with processor 154, memory 156, etc., can receive, from the first media player (e.g., media playing component 110), metadata including a timestamp and a question to be associated with the media content. For example, media playing component 110 can provide the metadata to the computing device 150, as described, such as when a question is asked via an interface provided by the media playing component 110. In this example, metadata managing component 162 can store the metadata in relation to the media content such to cause the metadata to be delivered with the media content or otherwise in response to a separate request identifying the media content.

In one example, storing the metadata can include a process for resolving potentially similar questions. In this example, metadata resolving component 166 can determine if a received question is similar to another question stored in the metadata for the media content. In one example, this can include metadata resolving component 166 determining whether the timestamp for the question is similar to a second timestamp stored in the metadata and if so determining whether the question is similar to a second question stored in the metadata for the second timestamp. If so, metadata resolving component 166 can refrain from storing the question as metadata for the media content and/or can cause the media player to display prompt notifying of the similar question, and ask whether the question should still be stored as metadata (and proceed accordingly).

In method 400, at action 404, a request for the media content can be received from a second media player. In an example, content managing component 160, e.g., in conjunction with processor 154, memory 156, etc., can receive, from the second media player (e.g., a media playing component 110 of the computing device 100 or another computing device), the request for the media content. For example, content managing component 160 can receive the request indicating the content, which may include a video, audio file, document, slideshow presentation, etc., as described, which may be stored on the computing device 150. In an example, an author of the content can upload the media content to the computing device 150 for sharing with other computing devices.

In method 400, at action 406, the media content and the metadata can be provided to the second media player for displaying the question in relation to the timestamp while rendering the media content. In an example, content managing component 160 and/or metadata managing component 162, e.g., in conjunction with processor 154, memory 156, etc., can provide the media content and the metadata to the second media player for displaying the question in relation to the timestamp while rendering the media content. For example, content managing component 160 can provide the media content and the metadata to the second media player (e.g., media playing component 110 of computing device 100 or another device) based on a request for the media content. As described, the metadata can include one or more questions and associated timestamps for displaying the questions during rendering of the media content at an appropriate time or progress.

In method 400, optionally at action 408, an indication of an answer for the question can be received from the second media player. In an example, metadata managing component 162, e.g., in conjunction with processor 154, memory 156, etc., can receive, from the second media player (e.g., media playing component 110 of computing device 100 or another device), the indication of the answer for the question. For example, the second media player can receive an answer for the question based on an interface provided for answering the question, such as a link to provide an answer displayed under the question, a pop-up displayed based on interacting with the question or a link around the question, etc. In any case, the answer can be associated with the question based on a portion of the interface interacted with to provide the answer. In an example, as described, the answer can include a text answer, a video, audio, a link thereto, etc.

In method 400, optionally at action 410, the answer associated with the question can be stored in the metadata for displaying, by media players, with the question. In an example, metadata managing component 162, e.g., in conjunction with processor 154, memory 156, etc., can store the answer in the metadata associated with the question for displaying, by media players, with the question. For example, metadata managing component 162 can store the answer in a data structure with the question and associated timestamp or as otherwise related thereto to facilitate retrieval with all metadata stored for the media content. The metadata can be provided to the requesting media playing component 110 to facilitate displaying the question and answer(s) for timestamps in the media content, as described.

Moreover, in an example, storing the answer may similarly involve a process for resolving potentially similar answers. In this example, metadata resolving component 166 can determine if a received answer is similar to another answer stored in the metadata for the question. In one example, this can include metadata resolving component 166 determining whether the received answer is similar to a stored answer. If so, metadata resolving component 166 can refrain from storing the answer as metadata for the media content and/or can cause the media player to display prompt notifying of the similar answer, and ask whether the received answer should still be stored as metadata (and proceed accordingly).

In method 400, optionally at action 412, a vote for one or more answers for the question indicated in the metadata can be received from the second media player. In an example, metadata managing component 162, e.g., in conjunction with processor 154, memory 156, etc., can receive, from the second media player (e.g., media playing component 110 of computing device 100 or another device), the vote for the one or more answers for the question indicated in the metadata. For example, the second media player can receive a vote for an answer for the question based on an interface provided for voting answers, such as a button for voting, a link to vote, a pop-up displayed based on interacting with the answer, etc. In any case, the vote answer can be associated with the answer and added to a vote count for the answer stored in the metadata.

In method 400, optionally at action 414, the vote can be stored as associated with the one or more answers for displaying with or ranking the one or more answers by media players. In an example, metadata managing component 162, e.g., in conjunction with processor 154, memory 156, etc., can store the vote as associated with the one or more answers for displaying with or ranking the one or more answers by the media players. For example, metadata managing component 162 can store the vote by adding the vote to a vote count for the answer as stored in the metadata, as described, and media players receiving the metadata can use the vote to display for or rank answers.

In method 400, optionally at action 416, an author of the media content can be notified of the question. In an example, question notifying component 164, e.g., in conjunction with processor 154, memory 156, etc., can notify the author of the media content of the question. For example, question notifying component 164 can send an email to the author along with a link for specifying an answer to the question. Where the author provides an answer to the question, for example, other questions can be blocked, displayed under the author's answer (e.g., with the author's answer as the first answer in the list regardless of votes), etc. In another example, question notifying component 164 can allow the author to adjust the media content in response to the question (e.g., to add content to answer the question, such as additional video, additional audio, etc.), as described further herein.

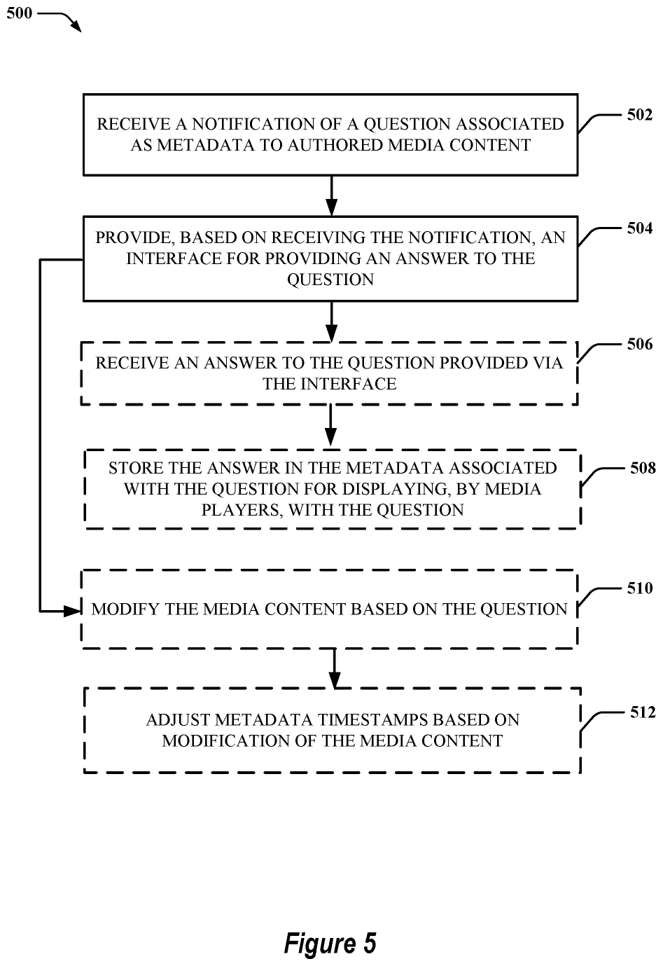

FIG. 5 is a flowchart of an example of a method 500 for modifying metadata or media content based on receiving an indication of a question associated with the media content. For example, method 500 can be performed by the computing device 100, and is accordingly described with reference to FIG. 1, as a non-limiting example of an environment for carrying out method 500.

In method 500, at action 502, a notification can be received of a question associated as metadata to authored media content. In an example, media managing component 120, e.g., in conjunction with processor 104, memory 106, etc., can receive a notification of a question associated as metadata to authored media content. For example, media managing component 120 can receive (e.g., from computing device 150 or another device storing media content or associated metadata) an email or other notification that a question is added to the metadata. For example, computing device 100 or an identifier of a user thereof, such as an email address, can be registered with the computing device 150 for receiving the notification.

In method 500, at action 504, an interface for providing an answer to the question can be provided based on receiving the notification. In an example, media managing component 120, e.g., in conjunction with processor 104, memory 106, etc., can provide, based on receiving the notification, the interface for providing the answer to the question. For example, media managing component 120 can provide the interface via a webpage, which may be accessed from computing device 150, for providing the answer for storing with metadata for the media content. As described, the answer may be a text answer and/or may cause modification of the media content to address the question.

In method 500, optionally at action 506, an answer to the question provided via the interface can be received. In an example, media managing component 120, e.g., in conjunction with processor 104, memory 106, etc., can receive the answer to the question provided via the interface, which can include receiving answer text, additional media content as the answer or to be used in modifying the original media content, etc.

In method 500, optionally at action 508, the answer can be stored in the metadata associated with the question for displaying, by media players, with the question. In an example, metadata managing component 162, e.g., in conjunction with processor 154, memory 156, etc., can store the answer in the metadata associated with the question for displaying, by media players, with the question, as described with respect to action 410 in method 400.

In method 500, optionally at action 510, the media content can be modified based on the question. In an example, media managing component 120, e.g., in conjunction with processor 104, memory 106, etc., can modify the media content based on the question. For example, media managing component 120 can allow for adding content to the media content in response to a question, such as adding video content to a video, adding audio content to an audio file, and/or the like. Media managing component 120 can provide the modified content to the computing device 150 for storing as the media content subsequently provided to other media players upon request. Adding content, however, may change the duration of the media content, and thus may impact other metadata (e.g., metadata with a timestamp after the point at which the media content is modified).

In method 500, optionally at action 512, metadata timestamps can be adjusted based on modification of the media content. In an example, media managing component 120, e.g., in conjunction with processor 104, memory 106, etc., can adjust the metadata timestamps based on modification of the media content. For example, media managing component 120 can provide information to computing device 150 for adjusting the timestamps in metadata corresponding to the media content, such as a time or progress at which content is added, a duration or length of the content, etc., and the computing device 150 (e.g., via metadata managing component 162) can accordingly adjust the timestamps.

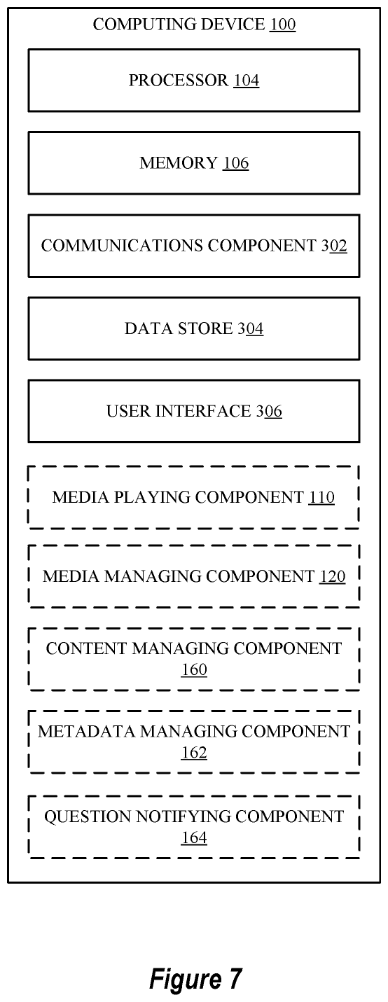

FIG. 7 illustrates an example of computing device 100 including additional optional component details as those shown in FIG. 1. In one example, computing device 100 may include processor 104 for carrying out processing functions associated with one or more of components and functions described herein. Processor 104 can include a single or multiple set of processors or multi-core processors. Moreover, processor 104 can be implemented as an integrated processing system and/or a distributed processing system.

Computing device 100 may further include memory 106, such as for storing local versions of applications being executed by processor 104, related instructions, parameters, etc. Memory 106 can include a type of memory usable by a computer, such as random access memory (RAM), read only memory (ROM), tapes, magnetic discs, optical discs, volatile memory, non-volatile memory, and any combination thereof. Additionally, processor 104 and memory 106 may include and execute an operating system executing on processor 104, one or more applications, such as media playing component 110, media managing component 120, content managing component 160, metadata managing component 162, question notifying component 164, and/or components thereof, as described herein, and/or other components of the computing device 100.

Further, computing device 100 may include a communications component 702 that provides for establishing and maintaining communications with one or more other devices, parties, entities, etc. utilizing hardware, software, and services as described herein. Communications component 702 may carry communications between components on computing device 100, as well as between computing device 100 and external devices, such as devices located across a communications network and/or devices serially or locally connected to computing device 100. For example, communications component 702 may include one or more buses, and may further include transmit chain components and receive chain components associated with a wireless or wired transmitter and receiver, respectively, operable for interfacing with external devices. For example, communications component 702 can carry communications between media playing component 110, media managing component 120, content managing component 160, metadata managing component 162, question notifying component 164 executing on another device (or the same device), etc., as described in various examples herein.

Additionally, computing device 100 may include a data store 704, which can be any suitable combination of hardware and/or software, that provides for mass storage of information, databases, and programs employed in connection with examples described herein. For example, data store 704 may be or may include a data repository for applications and/or related parameters not currently being executed by processor 104. In addition, data store 704 may be a data repository for an operating system, application, such as media playing component 110, media managing component 120, content managing component 160, metadata managing component 162, question notifying component 164, and/or components thereof, etc. executing on the processor 104, and/or one or more other components of the computing device 100.

Computing device 100 may also include a user interface component 706 operable to receive inputs from a user of computing device 100 and further operable to generate outputs for presentation to the user (e.g., via a display interface to a display device). User interface component 706 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, any other mechanism capable of receiving an input from a user, or any combination thereof. Further, user interface component 706 may include one or more output devices, including but not limited to a display interface, a speaker, a haptic feedback mechanism, a printer, any other mechanism capable of presenting an output to a user, or any combination thereof.

Computing device 100 can also include a media playing component 110 for playing media and/or displaying associated metadata, a media managing component 120 for managing media content stored on another device (or the same device), a content managing component 160 for managing media content for providing to various devices for rendering, a metadata managing component 162 for managing metadata related to the media content for providing along with the media content, and/or a question notifying component 164 for notifying of questions stored as metadata for media content, as described.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more examples, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various examples described herein. Various modifications to these examples will be readily apparent to those skilled in the art, and the generic principles defined herein may be applied to other examples. Thus, the claims are not intended to be limited to the examples shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various examples described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for obtaining and rendering media content by a computing device, comprising:
obtaining, from a remote source, media content for rendering in a media player;
obtaining, based on obtaining the media content, metadata related to the media content including an indication of a question related to the media content and a timestamp associated with the media content to which the question applies;
rendering the media content within the media player; and
displaying, by the media player and while rendering the media content, an indicator of the timestamp related to displaying the question.

2. The computer-implemented method of claim 1, wherein displaying the indicator comprises displaying the indicator based on the timestamp and a time associated with rendering of the media content.

3. The computer-implemented method of claim 1, wherein the indicator includes the question displayed in a frame of an interface of the media player, or a link to displaying the question.

4. The computer-implemented method of claim 3, wherein the metadata further includes one or more answers to the question, and further comprising displaying the one or more answers in the frame or as part of the link to displaying the question and the one or more answers.

5. The computer-implemented method of claim 4, wherein displaying the one or more answers comprises displaying the one or more answers in an order based on a number of votes received for each of the one or more answers.

6. The computer-implemented method of claim 1, further comprising displaying, based on the timestamp and a time associated with rendering of the media content, an interface to at least one of provide an answer to the question or vote for one or more answers displayed for the question.

7. The computer-implemented method of claim 1, further comprising:
receiving, during rendering of the media content and based on interaction with an interface, a second indication to associate a second question with the media content;
determining, based on receiving the indication, a second timestamp of the media content related to receiving the second indication;
receiving the second question to be associated with the media content; and
associating the second question and the second timestamp as additional metadata for the media content.

8. The computer-implemented method of claim 7, further comprising providing the additional metadata to the remote source for associating with the media content.

9. The computer-implemented method of claim 1, wherein the question is an initial post of a social discussion.

10. A computing device for associating metadata with media content, comprising:
a memory storing one or more parameters or instructions for associating the metadata with the media content; and
at least one processor coupled to the memory, wherein the at least one processor is configured to:
obtain, from a remote source, the media content for rendering in a media player;
obtain, based on obtaining the media content, the metadata related to the media content including an indication of a question related to the media content and a timestamp associated with the media content to which the question applies;
render the media content within the media player; and
display, by the media player and while rendering the media content, an indicator of the timestamp related to displaying the question.

11. The computing device of claim 10, wherein the at least one processor is configured to display the indicator based on the timestamp and a time associated with rendering of the media content.

12. The computing device of claim 10, wherein the indicator includes the question displayed in a frame of an interface of the media player, or a link to displaying the question.

13. The computing device of claim 12, wherein the metadata further includes one or more answers to the question, and wherein the at least one processor is further configured to display the one or more answers in the frame or as part of the link to displaying the question and the one or more answers.

14. The computing device of claim 13, wherein the at least one processor is configured to display the one or more answers in an order based on a number of votes received for each of the one or more answers.

15. The computing device of claim 10, wherein the at least one processor is further configured to display, based on the timestamp and a time associated with rendering of the media content, an interface to at least one of provide an answer to the question or vote for one or more answers displayed for the question.

16. The computing device of claim 10, wherein the at least one processor is further configured to:
receive, during rendering of the media content and based on interaction with an interface, a second indication to associate a second question with the media content;
determine, based on receiving the indication, a second timestamp of the media content related to receiving the second indication;
receive the second question to be associated with the media content; and
associate the second question and the second timestamp as additional metadata for the media content.

17. The computing device of claim 16, wherein the at least one processor is further configured to provide the additional metadata to the remote source for associating with the media content.

18. A computer-implemented method for obtaining and rendering media content by a computing device, comprising:
receiving, from a first media player, metadata, including a timestamp and a question, to be associated with the media content;
receiving, from a second media player, a request for the media content; and
providing the media content and the metadata to the second media player for displaying the question in relation to the timestamp while rendering the media content.

19. The computer-implemented method of claim 18, further comprising:
receiving, from the second media player, an indication of an answer for the question;
storing the answer in the metadata as associated with the question;
receiving, from a third media player, a request for the media content; and
providing the media content and the metadata to the third media player for displaying the question and the answer in relation to the timestamp while rendering the media content.

20. The computer-implemented method of claim 18, further comprising:
receiving, from the second media player, a vote for one or more answers for the question indicated in the metadata;
storing the vote as associated with the one or more answers;
receiving, from a third media player, a request for the media content; and
providing the media content and the metadata to the third media player for displaying the question and the one or more answers ranked according to votes in relation to the timestamp while rendering the media content.
